(19) United States
(12) Patent Application Publication
(10) Pub. No.: US 2004/0151849 A1
(43) Pub. Date: Aug. 5, 2004

(54) Acid-free recording device for use in scrapbooks

(76) Inventor: Susan J. Conley, Duluth, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/356,120

(22) Filed: Jan. 31, 2003

(51) Int. Cl. B32B 1/02

(52) U.S. Cl. 428/34.1

(57) ABSTRACT

This invention provides a memorabilia label to be used in conjunction with a scrapbook comprising of a recording device capable of recording and playing back messages, a substantially acid-free housing having a general outer periphery wherein the housing contains the recording device and the housing uses a substantially acid-free adhesive for adhering the housing to the scrapbook and wherein the outer periphery has a space for writing indicia.

### BACKGROUND OF THE INVENTION

Photo albums have a very long history. A decade ago several companies set out to improve and enhance the longstanding interest of preserving photos and memories. The improvement was in the form of acid-free photo albums, which solved the problem of “yellowing” photos and memorabilia over time.

The enhancement was in the form of adding stickers, lettering, designs and other new elements to the photographs with the intent of creating all-encompassing coveted heirlooms referred to in this new burgeoning industry as scrapbooks.

There has been an increased awareness as to measures to help preserve the integrity of photos and other objects in scrapbooks. It has been discovered that the environment that these items are kept in can have a drastic effect on how quickly the items degrade. Acids in paper, as well as lignins and Polyvinyl Chlorides (PVCs) have been found to produce environments, which accelerate the decay of paper, photographs and other keepsake items. These effects have been recognized in the scrapbook industry where pages in scrapbooks are typically treated to remove the acid that normally is produced by paper.

To assist in recollection of certain memories in scrapbooks, people often write down descriptions and journal entries to accompany articles in the scrapbook. However, writing down memories often fails to truly capture the essence of the event and/or persons photographed. This becomes particularly apparent in the heirloom value of the scrapbook as it is passed down from generation to generation.

A more effective method to assist in the recollection of an event would be to record an audio message in the scrapbook. Unfortunately, recording devices have not been designed for use in environments that are acid, lignin, and PVC sensitive. For example, U.S. Pat. No. 4,791,741 to Kondo describes a greeting card which has an audio recording device that can record and playback messages. Because these cards are not designed for use in acid sensitive environments, the recording device used in the card is not encased in such a way as to prevent the exposure of items in a scrapbook to harmful materials or vapors that are emitted by recording devices. Therefore, it would not be appropriate to insert this type of recording device into a scrapbook because it would accelerate the degradation of the memorabilia within the scrapbook. To produce a recording device that would be effective for a scrapbook, the recording device should be substantially acid-free. Therefore, there is a substantial need for the development of a recording device that can be used in environments that are acid, lignin, and PVC sensitive.

### SUMMARY OF THE INVENTION

A purpose of this invention is to provide a memorabilia label to be used in conjunction with a scrapbook comprising of a recording device capable of recording and playing back messages, a substantially acid-free housing having a general outer periphery wherein the housing contains the recording device and the housing uses a substantially acid-free adhesive for adhering the housing to the scrapbook and wherein the outer periphery has a space for writing indicia.

### BRIEF DESCRIPTION OF THE DRAWINGS

FIG. 1 is a top view of the memorabilia label containing a recording device.

FIG. 2 is a simple block diagram of the recording device.

FIG. 3 is a rear view of the memorabilia label containing a recording device.

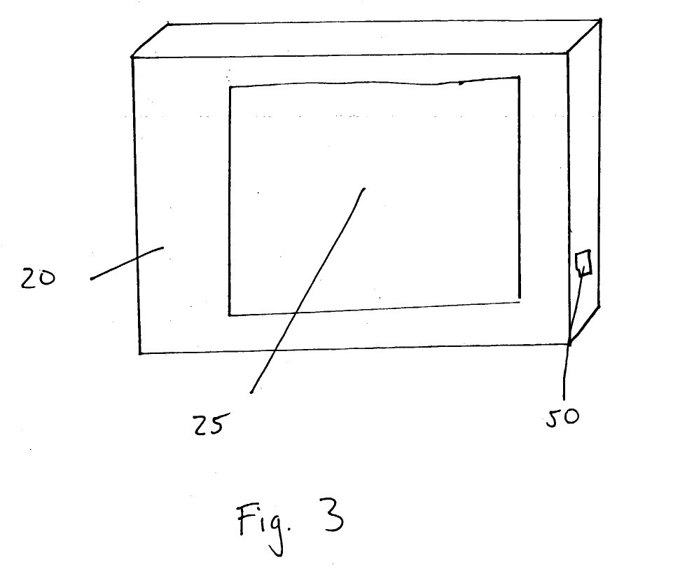

### DETAILED DESCRIPTION

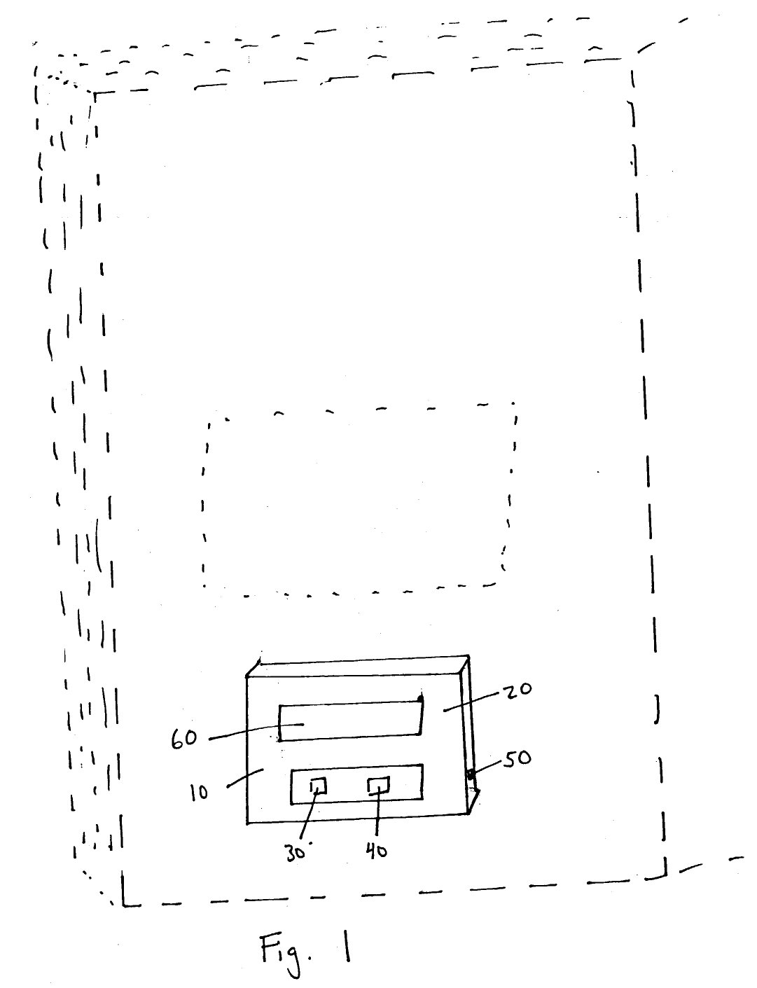

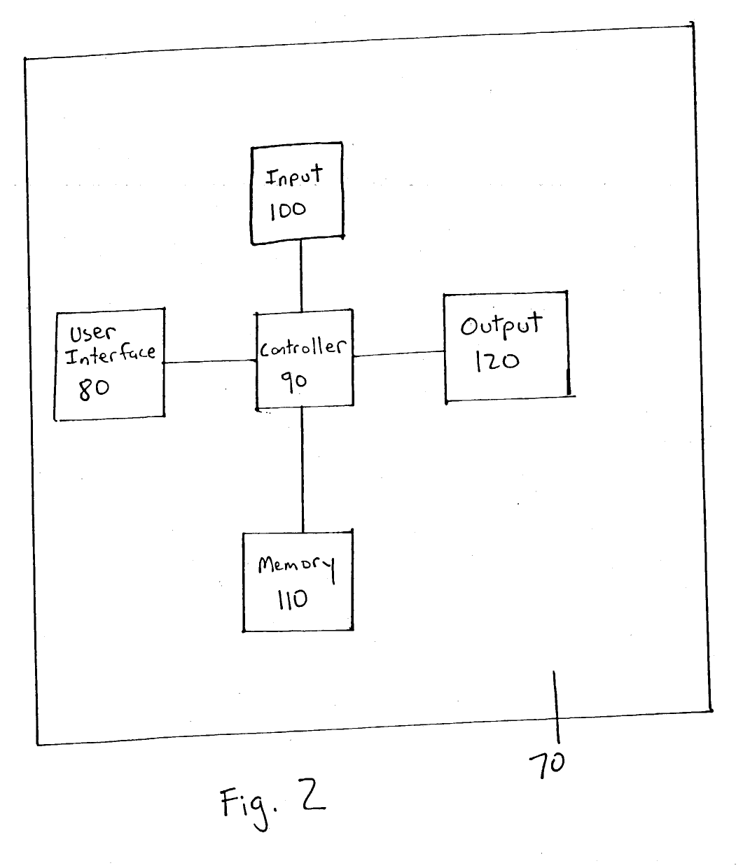

Referring now to the drawings, the invention will be described in more detail. FIG. 1 shows the memorabilia label in more detail. The memorabilia label 10 is designed to be used in connection with a scrapbook. The memorabilia label 10 includes a recording device 70, which is shown in FIG. 2, which is capable of recording and playing back messages and a substantially acid-free housing 20 which contains the recording device 70. A substantially acid-free adhesive 25 is utilized for adhering the housing 20 to a scrapbook. Different types of acid-free adhesives are known to those skilled in the art and could be used in this invention, including both permanent adhesives and repositional adhesives. The housing 20 also contains a writing indicia space 60 for incorporating written indicia. The housing 20 and the adhesive must be substantially acid-free to prevent the degradation of memorabilia in a scrapbook.

In another embodiment, the housing and the adhesive are also lignin-free because lignins can also have a similar degradating effect on memorabilia. In an additional embodiment, the housing 20 and the adhesive also do not contain Polyvinyl Chlorides because of the degradating effect that these types of compounds would have upon memorabilia that were to come into contact with or be exposed to in the scrapbook. Therefore, in some embodiments, the housing would be made from plastics such as polyester, polypropylene, polyethylene, polystyrene or a combination thereof because these plastics do not contain PVCs.

The memorabilia label 10 is designed to allow a user to record messages and play back these messages. Referring to FIG. 2, the recording device 70 is activated by user interface 80. User interface 80 in one embodiment may be an actuator such as a record button 30 which sends a signal to controller 90. Controller 90 activates an audio input 100 which allows the user to input some type of message. In a preferred embodiment, the audio input 100 is a microphone; however, any interface that is capable of conveying an audio signal to memory may be utilized. The audio signal is directed by controller 90 to a memory unit 110 which stores the audio input. One example of a memory unit is a RAM chip; however, one skilled in the art would recognize that other types of memory units may also be used. The user retrieves the message using a user interface 80, which may be represented by a play button 40. This button sends a signal to the controller 90 which retrieves the message from the memory unit 110 and sends the signal to an audio output 120. In the preferred embodiment, the audio output 120 would consist of a speaker. In some instances, a user may find it desirable to amplify the signal, which could be easily done by inserting an amplifier to amplify the signal before it is outputted by the audio output. In another embodiment, it may be desirable by the user to have a means of preventing the user from accidentally recording over a message that has been previously recorded. If this is the case, the recording device 70 could include a switch 50 for preventing a previously recorded message from being recorded over by a new message.

In a preferred embodiment, the recording device is powered by a power source. One skilled in the art would recognize that many different types of power sources may be used including but not limited to different types of batteries.

In a preferred embodiment, the housing 20 has a height that is preferably less than 5 mm, a width that is preferably less than 10 cm, and a length that is preferably less than 5 cm. It is important that the size of the housing 20 remains relatively small to make it practical to use with a scrapbook. In particular, the height of the housing 20 must be kept to a minimum to enable the housing 20 to properly fit inside the scrapbook.

The embodiments disclosed herein are understood to be illustrative and not limiting in any sense. It is intended that the scope of the present invention is not limited by the above described embodiments but by the claims and it covers all modifications equivalent to the claims.

What is claimed is:

1. A memorabilia label to be used in conjunction with a scrapbook comprising:
a recording device capable of recording and playing back messages,
a substantially acid-free housing having a general outer periphery wherein said housing contains said recording device and said housing uses a substantially acid-free adhesive for adhering said housing to said scrapbook and wherein said outer periphery has a space for writing indicia.

2. The label of claim 1 wherein said housing and said adhesive do not contain substantial amounts of lignin.

3. The label of claim 1 wherein said housing and said adhesive do not contain substantial amounts of Polyvinyl Chloride.

4. The label of claim 1 wherein said housing is made from a material selected from the group of polyester, polypropylene, polyethylene, and polystyrene.

5. The label of claim 1 wherein said housing was a height of less then 5 mm, a width of less than 10 cm and a length of less than 5 cm.

6. A memorabilia label to be used in conjunction with a scrapbook comprising:
a recording device capable of recording and playing back messages having an audio input, an audio output, a controller, a user interface, a memory, and
a substantially acid-free housing having a general outer periphery wherein said housing contains said recording device and said housing uses a substantially acid-free adhesive for adhering said housing to said scrapbook and wherein said outer periphery has a space for writing indicia.
